(19) United States
(12) Patent Application Publication
(10) Pub. No.: US 2003/0184544 A1
(43) Pub. Date: Oct. 2, 2003

(54) Modeling human beings by symbol manipulation

(76) Inventor: Jean Nicholson Prudent, Montreal (CA)

Correspondence Address: OGILVY RENAULT, 1981 MCGILL COLLEGE AVENUE, SUITE 1600, MONTREAL, QC, H3A2Y3, CA

(21) Appl. No.: 10/333,845

(22) PCT Filed: Jul. 24, 2001
(86) PCT No.: PCT/CA01/01070

(51) Int. Cl. G06T 15/00

(52) U.S. Cl. 345/419

(57) ABSTRACT

A character modeling and animation system provides a simple, efficient and powerful user interface that allows the user to specify the complex forms of human beings by creating visual sequences of symbol boxes. Each symbol box encapsulates a set of modifications that is preferably applied to a generic musculo-skeleton system in order to achieve the desired human being. The musculo-skeleton is made of relational geometry representing internal human structures bones, muscles, fat. The system automatically generates natural looking 3D geometry by applying the contents of the symbol boxes to the musculo-skeleton. The same user interface is used to model and generate human hair and clothing. Different human beings can be produced by directly manipulating the boxes and their content. Natural form and motion is achieved by using the musculo-skeleton to drive the external skin envelope during animation. The resulting symbol sequences can be merged with other sequences to produce new human beings.

### CROSS-REFERENCE TO RELATED APPLICATIONS

The application claims priority of U.S. provisional patent application No. 60/220,151.

### FIELD OF THE INVENTION

This invention relates generally to computer-based three-dimensional modeling systems and methods and specifically to a system and method that allows the highly realistic modeling of humans beings, including the human internal tissue system.

### BACKGROUND OF THE INVENTION

Computer graphics technology has progressed to the point where computer-generated images rival video and film images in detail and realism. Using computer graphics techniques, a user is able to model and render objects in order to create a detailed scene. However, the tools to model and animate living creatures have been inefficient and burdensome to a user, especially when it comes to generating models of lively human beings. Many basic aspects of the human body such as facial traits, musculature, fat and the interaction between hard and soft tissue are extremely difficult to describe and input into a computer system in order to make the three dimensional model of a human look and animate realistically.

The most prevalent technique for modeling human beings is to interactively model an empty shell made of connected three-dimensional geometric primitives. This process is similar to sculpting, where only the outside envelope is considered. This method requires artistic skills comparable to those of a master sculptor. Indeed, the best results using this technique have been achieved by accomplished multi-disciplinary artists-. Once the basic models are created, mathematical expressions have to be entered and associated to each three dimensional point on the shell in order to simulate the presence of internal bones, muscles and fat. Since simulating all internal tissues is unreasonably time-consuming, users will typically model only the obvious deformation such as a bulging biceps muscle.

One variation of the empty shell modeling technique is to use three dimensional scanning devices to obtain the geometry from a real actor. Laser light beams or sound waves are sent toward a live subject and the reflections are recorded to produce a large set of three dimensional points that can be linked into a mesh to form a skin shell or envelope.

Another variation of this technique is to extract three dimensional shell geometry data from a set of photographs. This technique only works for very low-resolution applications, since fine details are very difficult to extract from simple photographs. Furthermore, some details cannot be captured when a limb is obscuring another part of the body, as is common in photographs.

In both of these automated techniques, the basic external shapes of an actor are reproduced. But the resulting model is only a static representation since, unlike real humans, there are no internal structures such as bones and muscles connected to the outside skin. The resulting geometric shells cannot be properly animated until the same time-consuming techniques that are described above for interactive modeling are applied.

More recently, attempts have been made to model human beings with their internal structures. In these systems, tools are provided to model bones and then define muscles over them. In some cases, bones and muscles contain physical information like mass and volume. Although physically accurate, the resulting models do not look anything like real humans since bones and muscles are generated at low resolution in an effort to reduce the computational run-time. These models have also failed to help produce a realistic outside skin since they ignore the presence of fat and the effects of skin thickness, which would be too computationally demanding to be simulated by physics. As a result, this method is not used when realism is the main goal. See Wilhelms et al., “Animal with Anatomy”, IEEE Computer Graphics and Applications, Spring 1997 and See Scheepers et al., “Anatomy-based Modeling of the Human Musculature”, SIGGRAPH 97′ Proceedings, June 1997.

Musculo-skeleton modeling systems, developed for the ergonomics and biomechanics fields, model muscles as straight lines representing a system of virtual springs. See Pandy et al., “A Parameter Optimization Approach for the Optimal Control of Large-Scale Musculo-skeletal Systems”, Transaction of the ASME, Vol. 114, November 1992, pp. 450-460. These systems are strictly designed to obtain accurate numerical data for well-defined situations and do not include attachments to external skins. As such, they are unsuitable for realistic modeling and animation.

Attempts have been made to merge empty shell modeling with physical musculo-skeleton simulation. See Schneider et al., “Hybrid Anatomically Based Modeling of Animals”, Internal Memo, University of Santa Cruz, 1998. The approach is to fit a musculo-skeleton into an- already existing empty shell skin. The musculo-skeleton is then used to drive the deformation of the skin surface. While this approach does solve certain cosmetic problems that have plagued physical methods, it does not resolve the need to generate a realistic skin in the first place.

The “XSI” software from Softimage, the “Maya” software from Alias/Wavefront and the “3D Studio Max” from Kinetix represent the state of the art of currently available commercial systems.

The ability to share modeling assets among different projects is usually quite limited when using these systems. It is impossible to combine attributes from different characters in a routine manner. The primitive geometry that is inherent to existing systems require that new characters should begin from copies of individual existing ones or with a blank. Collaboration between artists is thus limited by the need to exchange very large data files that contain little in common with one another. Asset exchange and version management can tax the patience of all but the most resourceful animation project leaders.

The Intensive skill and labor requirements of these existing techniques have severely limited the use of high resolution human characters in film, broadcast, and interactive media. Good human models have been produced only by exceptionally skilled graphic artists, or by groups with the resources to purchase and manage complex and expensive equipment. Good animation-ready humans have been produced using these models only by highly skilled character setup experts. Due to the high cost and risk associated with developing a cast of 3D characters, only the most sophisticated studios have been able to achieve high quality human animation.

WO 98 01830 to Welsh et al. discloses a method of coding an image of an animated object, by using a shape model to define the generic shape of the object and a muscle model defining the generic arrangement of muscles associated with the object. The image is coded in terms of movement of the shape and/or muscle model, both the shape and the muscle model having a predefined interrelationship, such that when one of the models is conformed to the shape of a specific example of the object, the other of said models Is also conformed accordingly. The muscle model comprises information relating to predefined expressions, which information relates to which muscles are activated for each predefined expression and the degree of activation required, wherein, when the shape model is conformed to an object the degree of activation is adapted in accordance with the changes made to the shape model.

### SUMMARY OF THE INVENTION

Accordingly, an object of the present invention Is to provide a computer modeling and animation system which is simple to use and intuitive for the user.

Another object of the present invention is to provide a computer modeling and animation system which uses relational geometry, to allow the user to modify models with simple controls, Instead of requiring the direct manipulation of 3D points.

Still another object of the present invention is to provide a computer modeling and animation system which uses an interactive sequence of symbol boxes to facilitate modification of human models by the user.

According to a preferred embodiment of the present Invention, a method for generating a virtual character model data set is provided. The method comprises: providing a generic musculo-skeleton model containing skeleton, musculature, cartilage, fat and skin components in relational geometry, specifying a plurality of trait parameters each modifying one of the components of the generic musculo-skeleton model and generating an instance of the generic musculo-skeleton model using the plurality of trait parameters to obtain the virtual character model data set.

Accordingly, specifying a plurality of trait parameters can preferably comprise ordering the plurality of trait parameters and the trait parameters are applied to the musculo-skeleton model in the specific order. The method can preferably further comprise displaying the generic musculo-skeleton model, and displaying the instance of the generic musculo-skeleton model.

The instance of the generic musculo-skeleton model can preferably be generated after specifying each of the plurality of the trait parameters and the instance can preferably be displayed after specifying each of the plurality of the trait parameters.

Specifying the plurality of trait parameters can preferably be done using a selection of trait parameter groups. New trait parameters can preferably be specified by creating offset vectors to the generic musculo-skeleton model. Clothing and Hair can also preferably be defined.

In an interface, the user can first be presented with a generic default musculo-skeleton with a complete representation of internal human tissues and an external skin. The user specifies a sequence of modifications that have to be applied to this generic musculo-skeleton in order to produce the desired human being. These modifications are encapsulated inside individual “symbol box” user interface entities. A collection of symbol boxes forms a “symbol sequence” which fully describes the traits of the human being.

The method takes into account the fundamental symmetry of all humans, that is, the position of internal tissues varies immensely from one human to the next, but the relationship between neighboring internal tissues varies little. For example, a nose cartilage will always be at the same position relative to the cranium bone. To use this symmetry, a relational musculo-skeleton database is constructed.

The relational musculo-skeleton database is compiled from carefully built models of human body parts. Whenever a new human being is created, the database is used to generate a complete three-dimensional model. All changes to a human model are stored relative to one other as opposed to being stored using explicit positions. To change the shape of a nose cartilage for example, a symbol box is added to the symbol sequence. The box contains relational displacements that can be applied to a predefined set of relational control points. For example, the box will specify that for a specific nose shape, a set of control points is preferably moved by specific distances relative to each of their generic relative positions. The user does not see this complex data processing through the interface. Instead, simple graphical depictions of the nose cartilage shapes are provided as selections to apply to the current model.

The user interface and relational musculo-skeleton database make the human model generation engine. The user directs editing operations onto the human model by sending instructions to the database through modifications to a sequence of symbol boxes. Simple editing controls can thus be used to generate large scale manipulations of the human's internal tissues, external skin, hair, and clothing. All of these controls are real-time interactive, by virtue of the optimized translation of editing instructions to the database, and then to visual display drivers on the computer.

It will be apparent to those skilled in the art that the present invention can be carried out over a network, wherein some of the steps are performed at a first computer and other steps are performed at another computer. Similarly, the components of the system can be located in more than one geographical locations and data is then transmitted between the locations. It will be further understood that the whole system or method can be provided in a computer readable format and the computer readable product can then be transmitted over a network to be provided to users or distributed to users.

### BRIEF DESCRIPTION OF THE DRAWINGS

These and other features, aspects and advantages of the present invention will become better understood with regard to the following description and accompanying drawings wherein:

FIG. 1 is an illustration of a computer system suitable for use with the present invention;

FIG. 2 is an illustration of the basic sub-systems in the computer system of FIG. 1;

FIG. 3 is a block diagram showing the main components of the invention;

FIG. 4 is a screen display of a computer system according to the present invention, showing the-main symbol sequence editing interface.

FIG. 5 is a screen display according to the present invention, showing the contents and interface of a particular attribute symbol box: skin attributes.

FIG. 6 is a screen display according to the present invention, showing the contents and interface of a particular building block symbol box: cranium selection.

FIG. 7 is a screen display according to the present invention, showing the contents and interface of a particular modifier symbol box: hairstyle shaping.

FIG. 8 is a screen display according to the present invention, showing the contents and interface of a symbol blending box: cranium shape blending.

FIG. 9 is a flow chart of the human design process according to the present invention;

FIG. 10 is an illustration of the grouping of symbol sequences into libraries and the assignment to 3D scene humans;

FIG. 11 is an illustration of the components of a 3D scene human;

FIG. 12 is an illustration of the layers of the relational musculo-skeleton;

FIG. 13 is an illustration of the relational geometric layers of the musculo-skeleton;

FIG. 14 is an illustration of the relational encoding apparatus; and

FIG. 15 is an illustration of some internal surface geometries and their offset vectors.

### DESCRIPTION OF THE PREFERRED EMBODIMENT

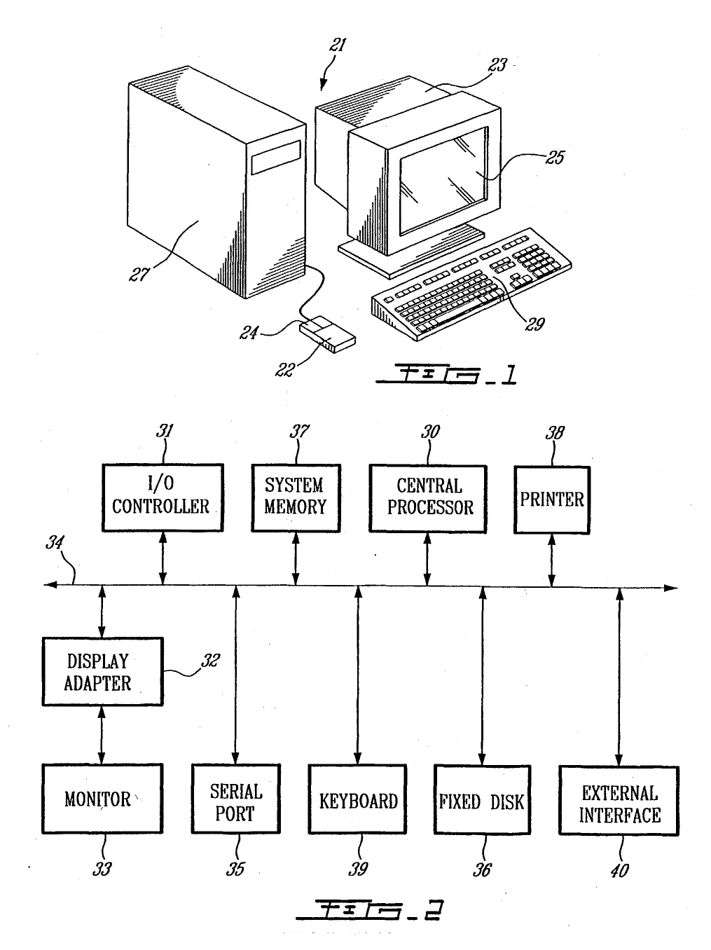

FIG. 1 is an illustration of a computer system suitable for use with the present invention. FIG. 1 depicts only one example of many possible computer types or configurations capable of being used with the present invention. FIG. 1 shows computer system 21 including display device 23, display screen 25, cabinet 27, keyboard 29 and mouse 22. Mouse 22 and keyboard 29 are “user input devices.” Other examples of user input devices are a touch screen, light pen, track ball, data glove, etc.

Mouse 22 may have one or more buttons such as button 24 shown in FIG. 1. Cabinet 27 houses familiar computer components such as disk drives, a processor, storage means, etc. As used in this specification “storage means” includes any storage device used in connection with a computer such as disk drives, magnetic tape, solid state memory, optical memory, etc. Cabinet 27 may include additional hardware such as input/output (I/O) interface cards for connecting computer system 21 to external devices such as an optical character reader, external storage devices, other computers or additional devices.

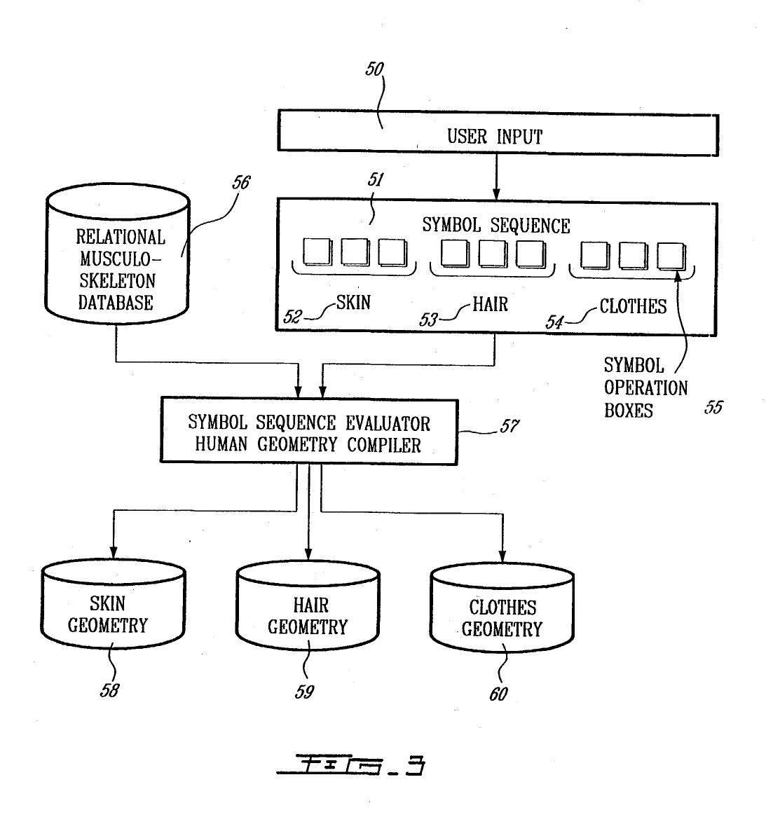

FIG. 2 is an illustration of the basic subsystems in computer system 21 of FIG. 1. In FIG. 2, subsystems are represented by blocks such as the central processor 30, system memory 37, display adapter 32, monitor 33, etc. The subsystems are, interconnected via a system bus 34. Additional subsystems such as printer 38, keyboard 39, fixed disk 36 and others are shown. Peripheral and input/output (I/O) devices 31 can be connected to the computer system by, for example serial port 35. For example, serial port 35 can be used to connect the computer system to a modem or a mouse input device. An external interface 40 can also be connected to the system bus 34. The interconnection via system bus 34 allows central processor 30 to communicate with each subsystem and to control the execution of instructions from system memory 37 or fixed disk 36, and the exchange of information between subsystems. Other arrangements of subsystems and interconnections are possible.

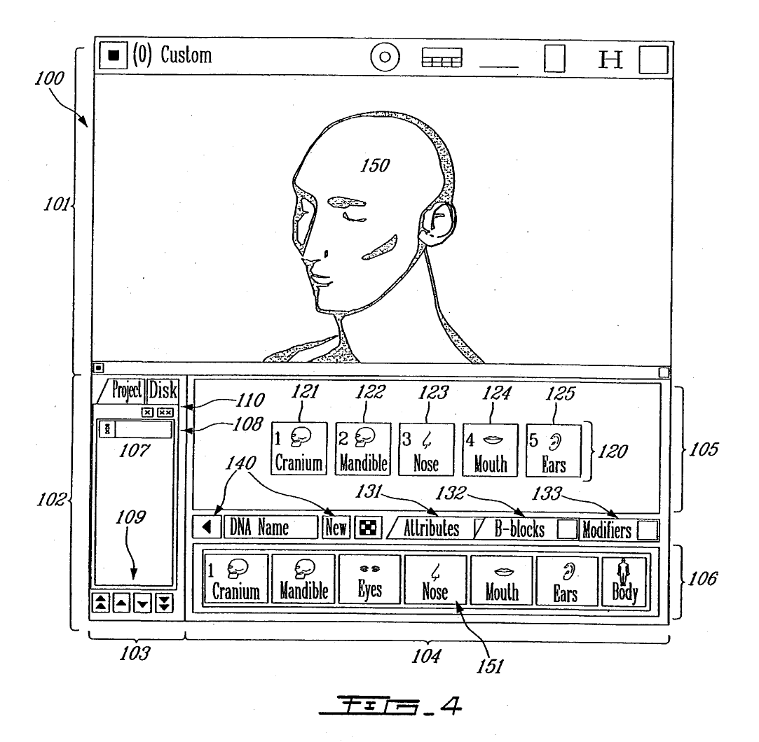

FIG. 3 illustrates the high level architecture of the present invention. A relational musculo-skeleton database 56 is built into the computer system. It contains data necessary for the Symbol Sequence Evaluator 57 to be able to reproduce human skin 58, hair 59, and clothing 60 geometries. A particular human character is customized according to user input from a computer mouse and keyboard 50 applied to a particular Symbol Sequence 51. The user input determines which Symbol Operation Boxes 55 are assigned to the Symbol Sequence 51, and determines the contents of each of these boxes with respect to the Skin 52, the Hair 53 and the Clothes 54.

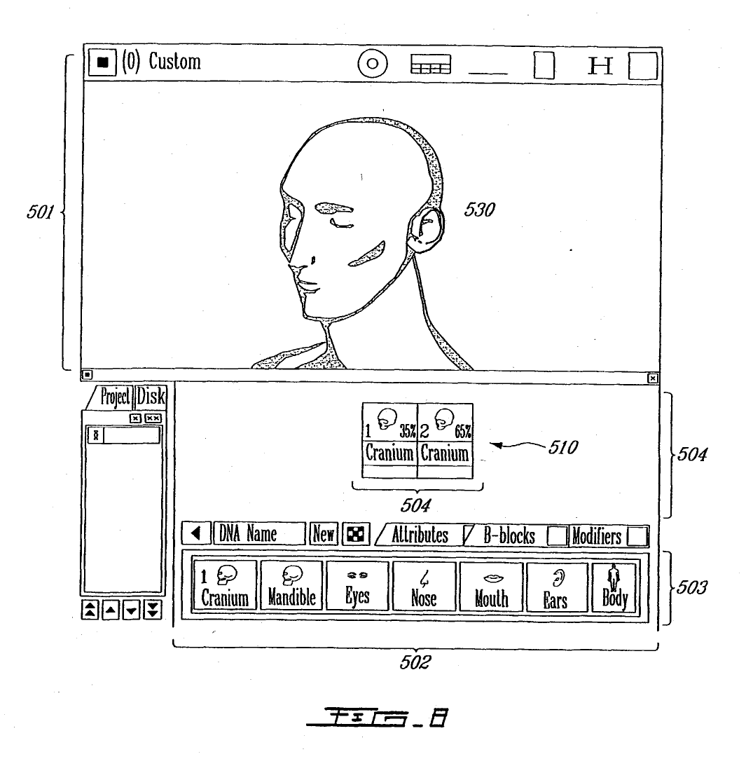

The design process of the invention is shown in the diagram of FIG. 9. The user begins by creating a new symbol sequence 45. He adds symbol boxes to a symbol sequence 46. Each time a change is made, the Symbol Sequence Evaluator automatically reapplies all the symbol boxes sequentially from left to right to the musculo-skeleton 47. A default skin envelope is then evaluated over the musculo-skeleton and the result is shown to the user for approval 48. The user can then choose to continue to edit the symbol sequence 46 or to save it to a library 49.

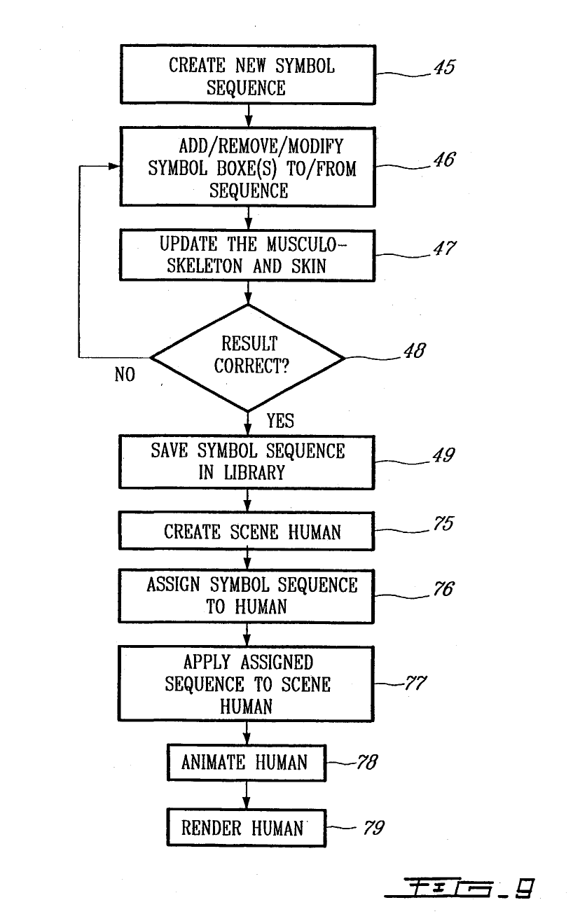

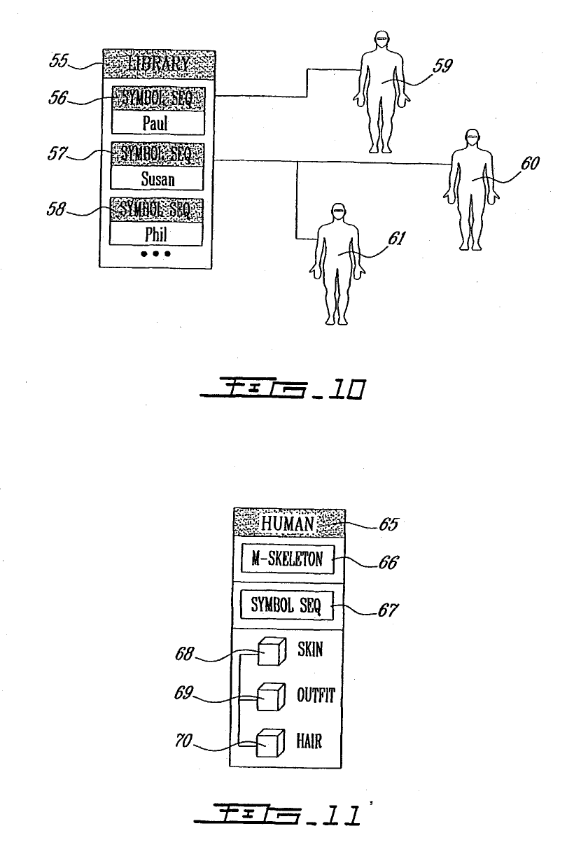

Unlike other human modeling systems, the definition of a human by a symbol sequence is independent from the actual 3D models that appear in a scene. This way, only the sequence needs to be stored: the human geometry itself can be generated on demand, and can thus be disposed of. As illustrated in FIG. 10, any given sequence 56, 57 or 58 from the library 55 can be assigned to any human 59, 60 or 61 and a single sequence 57 can be assigned to many humans 60 and 61. This capability makes it possible to control the look of a group of characters with very little data. The contents of each 3D human 65 are shown in FIG. 11 where it is apparent that only the sequence assignment 67 needs to be saved: the relational musculo-skeleton 66, and the skin 68, hair 70 and clothes 69 geometries can all be generated on demand by passing the sequence to the Symbol Sequence Evaluator.

The design may be summarized as shown below in Table 1 and in FIG. 9:

TABLE 1
3D Human Design Steps

| | |
|---|---|
| User creates/reads/edits the Symbol Sequence | 45, 46 |
| of the human to create. | |
| Program evaluates sequence and applies the | 47 |
| result to a test 3D human. | |
| Repeat steps 46 and 47 until the test human is satisfactory. | 48 |
| User adds Symbol Sequence to a library. | 49 |
| User creates one or more scene humans. | 75 |
| User assigns a symbol sequence to every scene human. | 76 |
| Program applies assigned sequences to all scene humans | 77 |
| and creates their geometry. | |
| User interactively creates a linear sequence of poses | 78 |
| for animation. | |
| Program renders final images of human animation. | 79 |

FIG. 4 shows a screen display of a computer system according to a preferred embodiment of the present invention. Screen display 100 is designed to show an overview of the various aspects of the user interface of the human modeling program. In screen display 100, a Symbol Sequence editing window 102 is positioned beneath a human viewing window 101. Other components of the system are not shown.

Within the Symbol Sequence editing window 102 is the Library Management interface 103 and the Sequence editing interface 104. Interaction with user interface components is done using the computer mouse.

The Library Management Interface 103 is used to control the archiving of Symbol Sequences to storage. Sequences can be named, stored, retrieved, copied, and deleted from any number of Symbol Sequence library files, using the control buttons 109 and 110. When a Sequence Library is opened, each Sequence contained within it is listed in the Sequences display list 107. An individual Sequence 108 may then be selected, and its contents displayed in the Sequence editing interface 104.

Symbols are abstract visual entities that represent something else. Herewith, a symbol represents a human DNA “genetic engineering” operation.

As illustrated in FIG. 4, the Symbol Sequence is a user interface paradigm that is used to represent the modifications that are preferably applied to a default musculo-skeleton in order to generate a new human character with desirable traits. In the preferred implementation, the user is presented with an image of the default musculo-skeleton with a skin surface enveloping it 150. The user then chooses among a pool of available symbolic modifications and adds instances of the symbols to the active symbol sequence 120.

As illustrated in FIG. 10, Symbol Sequences 56, 57 and 58 are stored in libraries 55 from which they can be assigned to actual humans 59, 60 and 51 in a 3D scene. Sequences can be assigned to any human model, and the model only needs to store a reference to the library data. Several humans can share the same symbolic component (DNA, Outfit or Hairstyle, for example).

In FIG. 4 the Sequence editing interface 104 shows the current Symbol Sequence 120 inside of the Sequence display view 105, which is a collection of individual Symbol Boxes 121-125. This Sequence may start with a blank list to which Boxes are then added, or with an existing sequence selected from the Library Management interface 103. Whenever a Box is added or modified, the current human 150 in the human viewing window 101 is preferably recomputed by the processor and redisplayed.

In the preferred embodiment, there are three categories of available symbol boxes: the attributes 131, the building blocks 132 and the modifiers 133.

The active category is chosen by selecting the category selection tab. Once a category is selected, all of its members are shown in the Symbol Selection view 106. To add a new Symbol Box to the current sequence, the user navigates through the choices by scrolling, and then selects the desired Symbol. A new instance of that symbol is then added to the Sequence 120.

The Symbol Boxes 121-125 which comprise the example Sequence 120 include: a cranium bone 121, a mandible bone 122, a nose cartilage 123, a mouth cartilage 124, and cartilage for both ears 125. These were each selected from the “Building Blocks” category 132.

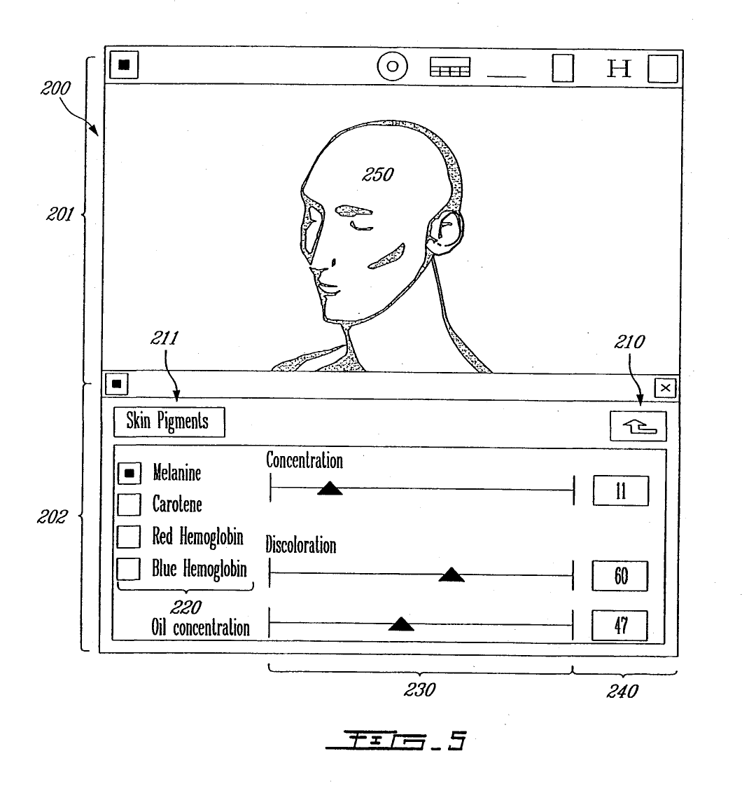

In FIG. 5, the contents of an “Attributes” 131 category symbol box are shown. Attributes include Symbols for such things as clothing properties, the appearance of hair and skin, and certain parameters used to control the rendering of these components. When an Attribute symbol is selected, a parameter editing interface 202 is presented to the user for input. In this example, a Skin Pigment symbol box 211 is shown and used to assign skin pigment characteristics to the human's skin surface 250. The current parameter is selected from a list 220, and values are assigned using slider controls 230, or by direct numeric input into the corresponding fields 240. As these parameters are changed, the human 250 display is preferably updated to show an example of the resulting skin.

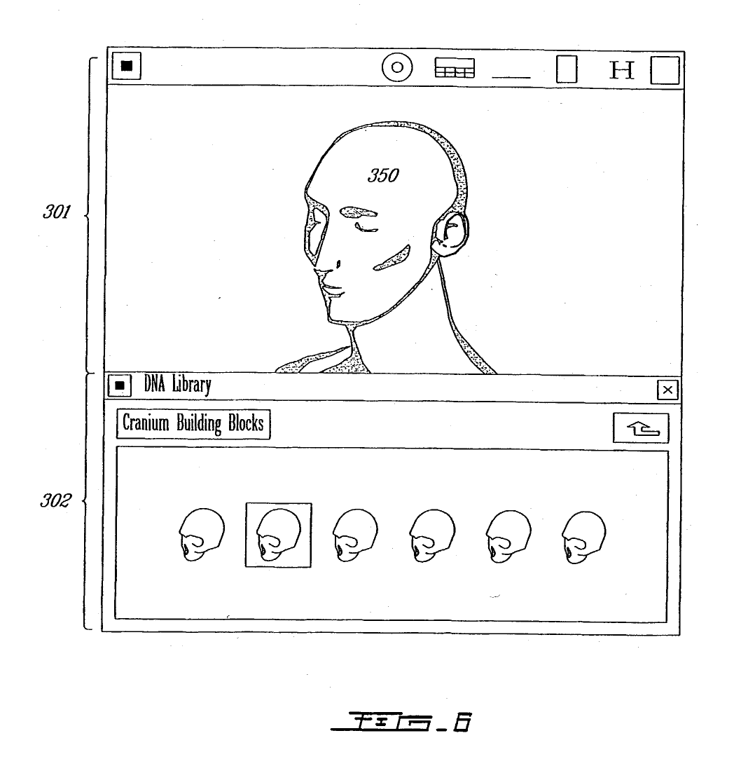

In FIG. 6, the contents of a “Building Blocks” category 132 symbol box are shown. Building Blocks include symbols for the most fundamental aspects of the current human 350, such as the overall head and body shape, facial features, hairline, and hairstyle. When a Building Block symbol is selected, a palette of options 302 is presented to the user for selecting the most appropriate description of the body part. In this example, a Cranium symbol box is used to assign a cranium shape to the human 350. When a particular shape is chosen from the palette 302, the human head display 301 is updated to show a completely new shape. All facial features and the external skin are rebuilt to accommodate the new cranium bone structure.

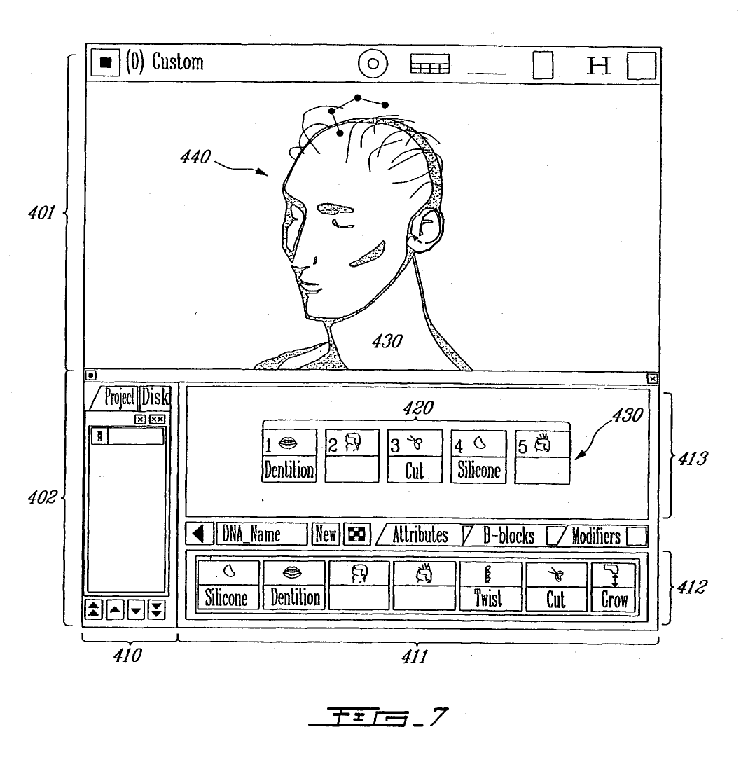

In FIG. 7, the contents of a “Modifier” category 133 symbol box are shown. Modifiers include Symbols that describe the specific placement and qualities of muscle, hair strands and other body components. For example, hair strands can be twisted, curled, cut to length, and braided. Musculature can be modified to exaggerate certain features. Whenever a specific Symbol is selected, the human viewing window 401 preferably changes to accommodate the appropriate view of the current human 450. For example, when the nose Symbol Box is selected, the view is centered upon the front of the face.

When a Modifier Symbol is selected, the view changes to accommodate whatever editing interface is appropriate for that Modifier. In this example, the “Hair Placement” Modifier symbol box 430 of the symbol sequence 420 is selected, and the three dimensional editing interface that includes the hair positioning tools 440 is active in the human viewing window 401. To change the position of hair bundles, the user selects facsimiles of individual hair strands, and interactively moves control points in 3D until the desired results are achieved. These position editing operations are stored in the symbol box contents as displacements from the base building block hairstyle.

Any Sequence can be modified by selecting any Symbol Box, and then altering its contents. For example, in FIG. 4 the nose Symbol Box 123 was created by selecting the Nose Symbol 151 from the symbol selection view 106. A different nose can be substituted by selecting the Nose Symbol Box 123, and then choosing another option from a palette of mandible.

The process of modifying the Symbol Sequence 120 can continue indefinitely. When the user is satisfied with a particular sequence, it may be saved to the current Symbol Sequence library by using control buttons 140. Editing can continue, and any number of new sequences can be added to the library.

In addition to simple groups of individual symbol boxes, the Symbol Sequence can also contain compound blended symbols. This is illustrated in FIG. 8, which shows an example of a very short sequence 504 that is comprised from two symbol boxes that are connected together in a blending operation 510. These two symbol boxes were created by instancing two different Cranium symbols from the Building Blocks category 503. Each symbol contains a different cranium building block definition. When the compound symbol 510 is blended, the resulting cranium formed on the human 530 is a linear blend between the two distinct shapes. Such shape blending operations make it possible to create any new cranium shape, while maintaining the integrity of all facial features and musculature. When combined with other custom shape editing symbols, the range of possible head shapes becomes unlimited.

There is no limit to the number of blending operations that can be added to a symbol sequence. But there is a limit to the number of possible combinations. In the case of building blocks, only similar building block symbols can be blended. For example, ears cannot be blended with noses. In the case of attributes, only identical attributes can be blended together. For example, hair color attributes symbols can only be blended with other hair color attribute symbols. In the case of modifications, only symbols that act upon the same body parts can be blended together. For example, hair twisting symbols can only be blended if they are constructed upon the same base hairstyle.

Blending can be done at a much higher level by using DNA Libraries. For example, it is possible to create separate DNA Libraries for head construction, upper body construction, and lower body construction. DNA sequences from these three sources could then be quickly assembled to produce a variety of unusual human forms. Such assemblages would make the special effect of character “morphing” quite simple.

A relational musculo-skeleton database is preferably kept intact during the entire Symbol Sequence editing process described above. As illustrated in FIG. 9, this database is updated by the processor 49 after each Symbol Box operation. The updating functions are handled by a Symbol Sequence Evaluator, which consists of a number of optimized geometric element processing functions.

Usually, 3D databases represent geometric elements as Euclidean (x,y,z) coordinates in space which are connected together to form curves and surfaces. In a relational geometric database, each point is stored in terms of its relationship to previously-defined entities, rather than as 3D positional data. Geometric elements are defined by these relationships and built out of parametric surfaces that are uniquely determined by these relationships. Given a pair of parameters (u,v), it is possible to deduce the three dimensional location of any point on such a surface.

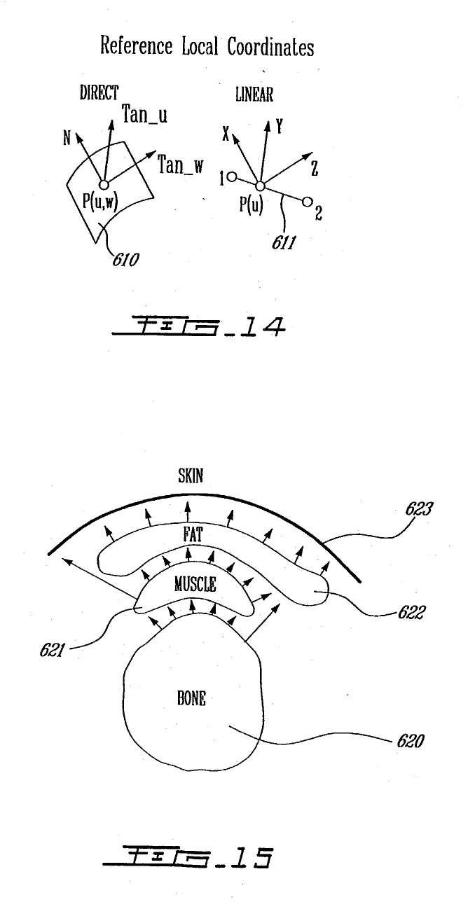

This relationship is illustrated in FIG. 14, where a surface point is evaluated in its “direct” surface coordinate system 610, and its “linear” coordinate system 611 along a line segment. This “linear” system 611 contains relationships between a point along a line and its Euclidean coordinates, so that correspondence between the two representations can be deduced.

In the preferred implementation, Non-Uniform-Rational-B-Splines (NURBS) are used to model all of the tissues of the musculo-skeleton. NURBS are the most generic representation of parametric surfaces and can represent both flat and curved elements. They were chosen as the basic modeling unit for the following reasons. Because NURBS incorporate parametric splines, they can produce organic shapes that appear smooth when displayed at all magnifications and screen resolutions. NURBS have straightforward parameter forms which can be used to map 2D coordinates over a rectangular topology. This ensures compatibility with polygonal modeling and rendering technologies. Details can be added to an existing surface without loss of the original shape through a process called “node insertion”.

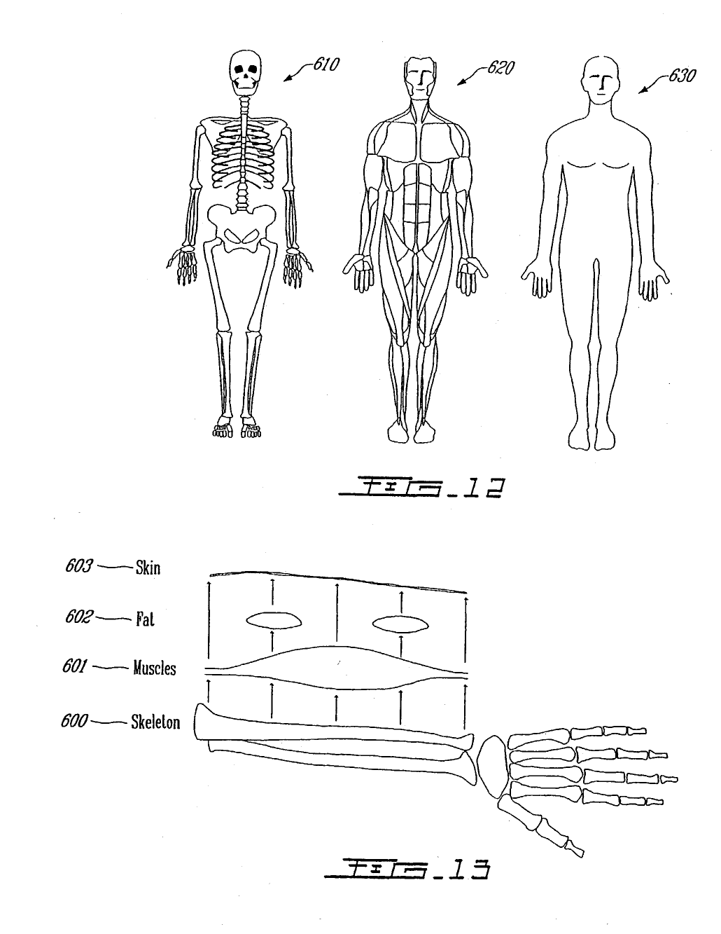

In the preferred implementation, the musculo-skeleton is built from a large number of independent NURBS surfaces, each of which simulates the form of a human body part. Each internal surface is acted upon by other surfaces, and in turn acts upon other surfaces. The outer skin is completely controlled by the characteristics of the assemblage of these internal surfaces. FIG. 13 illustrates this coupling hierarchy: a bone 600 is the “root” object that effects muscles 601 attached to it; muscles 601 in turn act upon fat 602 surfaces, or directly onto the outer skin; fat 602 acts upon the outer skin 603 only.

As illustrated in FIG. 12, the internal tissues are arranged similarly to those on the human body (skeleton 610, muscles 620 and skin 630), with the following exceptions. Internal organs like the heart and lungs are not modeled, since they have no noticeable effect on the outer form of a human being. The fat between the organs is not modeled, for simplicity. Some internal bones are not included, when they have no direct effect on skeletal function or appearance.

Generic humans are built into the computer system using these techniques. Preferably, users do not have access to the low-level details of these internal tissues. Instead, they interact with the database using the high-level design mechanisms described above.

The final “look” and quality of the built-in generic humans is very dependent on the skill of the modeling artist. Once an artist has generated a model of a NURBS body part in 3D, it is ready to be transformed into its relational musculo-skeleton form and stored in the database.

The method requires modeling the tissues of the human body for purposes of describing them within the relational musculo-skeleton database. All models are built in such a way as to minimize the amount of data required to reproduce them, and to maximize their relational interaction with other models. All tissue models are preferably built in three dimensions, with attention to how they will be defined in two dimensional relational geometry.

All bones that have an influence on visible tissues are built first, using information from medical anatomy references. The topology of NURBS representation should adhere to the lines of symmetry of each bone, so that the number and density of curves is reduced to the minimum required for capturing the details of the surface protrusions. Each bone is preferably modeled in situ, so that its relationship to other bones adheres to human physiology. These bones are the infrastructure that drives the displacement of all other tissues during animation.

Because bone surfaces are topologically closed, they project normal vectors outwards in all directions, as shown in FIG. 15. These vectors should project onto muscles, ligaments, and tendons with great accuracy, especially around joints. Each surface point on a bone 620 is preferably unambiguously associated with a point on the tissue built on top of it. This one-to-one mapping is preferable for all tissue layers if continuity of effect is to be preserved.

Muscle 621 and connective tissue surfaces are modeled directly on top of the bone surfaces. A low error tolerance is preferable for the modeling process, because any details of these tissues that are not replicated will be unavailable to the outside skin layer.

Fat tissue 622 is modeled directly on top of the muscle and connective tissue layers. This tissue can appear in concentrated-pockets, such as exist in the cheeks and in female breasts, and it can appear in layered sheets, such as exist in the torso, arms, and legs of humans with high body fat ratios. Such tissue is modeled in the same way that muscle is modeled. The characteristic fat distribution of an average human adult is built into the generic human model. Large variations in fat distribution occur among the human population, so fat tissue collections are built in such a way that they can be rapidly exchanged and modified using the modifier symbol box interface described above.

This entire collection of tissue models defines the generic human model that is compiled into the relational musculo-skeleton database. The final modeled layer that covers all of these tissues is the outer visible skin 623 of the human. This layer is preferably a single topologically closed surface that tightly encompasses all of the internal tissues. Since this surface is preferably able to encompass a wide variety of internal tissue distributions with high accuracy, it is built with a tight tolerance atop all of the generic human model contents. This surface is the only one that is actually rendered, so-it is preferably of sufficient resolution to clearly demonstrate the effect of all the positions and deformations of internal tissues.

Once all of these components are built, the relational musculo-skeleton database can be constructed directly from the hundreds of individually modeled surfaces. This is done recursively, starting from the bone surfaces and moving outwards, as shown in FIG. 15. Each NURBS control point on the superior (innermost) surface is associated with an offset vector to its inferior (outermost) surface using the algorithm shown in Table 2.

TABLE 2
Algorithm for associating an offset vector to a NURBS control point.

Represent each surface in 2D u, v coordinates
Find the index of the closest inferior surface to the current superior surface
For all points on the superior surface, find closest point on inferior surface
Calculate the 3D difference vector between these two points
Store the offset vector in the relational database

The database thus contains the complete description of all surfaces, with the starting reference being the individual bone surfaces. The entire human model can thus be constructed from the database by using the algorithm of Table 3.

TABLE 3
Algorithm to construct human models.

Place the bone into its preferred position
For all points on the inferior muscle and connective tissue surfaces,
calculate their location using the stored offset vector
For all points on inferior fat tissue surfaces, calculate their location using
the stored offset vector from the muscle and connective tissue surfaces
For all points on the external skin surface, calculate their location using
the stored offset vector from the applicable superior surface

In this method, undesirable deformations of tissues are avoided by using NURBS control points from carefully constructed models which take into account the expected direction of deformation. A skilled modeler can anticipate the symmetry of tissue deformations and draw collections of control points that will ensure surface continuity when each point is moved a considerable distance from its starting position. This is because adjacent points on a model will not move very far apart. Tissues in the human body appear elastic because they deform over most of their mass, and not in one small region.

The method is extended to collections of interchangeable body parts by applying the same modeling and compilation algorithms to libraries of new models. Each of these models begins as a copy of the generic model. It may then be modified using a number of standard geometric operations. As long as the new model remains topologically similar to the generic model, it can be changed without limit. Each model is then compiled-into the relational musculo-skeleton database preferably in the same manner as its generic version.

Because the database compiling algorithm works the same way no matter what surfaces are present, one internal body part can be replaced With another. The database simply replaces all references to the original body part with the new body part, and recalculates and stores the new offset vectors. Building blocks can thus be created in a myriad of unique shapes, while retaining their compatibility with all of the body parts around them. Building blocks can be saved as individual pieces or collections of bones, muscles and connective tissue, and fat tissue. For example, a group of nose building blocks can be constructed for selection in a symbol box, or a group of highly developed shoulder muscles can replace the generic average muscle group.

The method is extended to incorporate modifier and attribute symbol boxes by applying a variation of these compiling techniques. In modifier symbol boxes, further editing of the models can be done by the user through the graphical interface. All of these editing operations change the body part in some way, and these changes can be described as displacements from the generic model by applying the relational compiling algorithms, or other similar techniques.

In attribute symbol boxes, simple -parameters can be set to values that differ from the generic model, such as the curliness of hair. Many of these parameters are used only in the rendering process, and have no connection to the database. Attribute symbols may or may not require compilation into the database, depending upon the particular human traits that they modify.

The method ensures that menus, palettes, and selectable options built into the system for the user's benefit can always be expanded by adding new relational models to the database. There is no limit to the number of possible permutations, other than the amount of storage resources available to hold all of the data. Given the small amount of data required to encapsulate each new addition, and the cheap availability of storage media, a population of millions of unique characters could be able to interchange their body parts at will. All trait sharing is accomplished using the symbol sequence editor.

After each Symbol Box editing operation is completed, the musculo-skeleton is re-generated by evaluating the sequence from left to right. The contents of each symbol are applied to the relational musculo-skeleton database. The database can then be used to display the resulting human character to the human viewing window.

To apply a symbol to the relational musculo-skeleton database, an algorithm is used to convert the symbol contents to primitive operations that act either directly upon NURBS surfaces or upon rendering attributes assigned to those surfaces. The built-in encoding of each symbol type includes instructions on how the database is to perform these conversions. Because the relational database keeps a list of all the things that need to be updated when a given element is changed, added, or deleted, the updating process avoids re-computing data that does not change during each symbol evaluation.

Users of the computer system are never exposed to the complexities of symbol evaluation. From the user's point of view, each symbol is a self contained operation that performs its alterations on the human from whatever context it is applied. Identical results are guaranteed from the evaluation of identical sequences. Different results may occur when any change is made to a sequence, including the left to right ordering of symbol boxes.

In the preferred implementation, the skin of the human model 150 in FIG. 4 is drawn to the computer screen by sending a series of graphic instructions to the processor. Each instruction includes details on how to draw a portion of the skin surface. These instructions are sent in a format that is used by common computer graphic “pipelines” built into hardware.

The skin is constructed as a single continuous surface that maintains its topology no matter how it is deformed by the tissue models underneath. A built-in skin model that tightly encompasses all of the internal tissues is created by a skilled artist. After the skin is compiled into the relational musculo-skeleton as described above, it can be made to conform exactly over the bone, muscle, cartilage, and fat tissues previously modeled. Skin attachment and deformation properties are handled by the relational database, so that the computer system user can avoid dealing with direct modeling functions.

Skins models can be saved to skin model libraries. A skin from any of these libraries can be attached to any human model. Preferably, the computer system includes tools that allow users to create new or modified skin models. Different skins can then be used to achieve better results- for a variety of different display resolutions and human shapes. For example, at high display resolutions, a denser mesh will yield better results, so for up-close facial shots a skin model with dense facial features but sparse lower body features will work best. For this reason, the computer system preferably comes equipped with a skin model library for a variety of purposes.

In the preferred implementation, hair is modeled, simulated, and rendered using a subsystem that gives the Symbol Sequence Evaluator full access to all hair data. Basic hairstyles are compiled into building blocks in the same manner as those for cranium and mandible building blocks. Each building block symbol contains a complete description of both the hairline and the shapes of hundreds of bundles of hair strands. Because hairstyles are part of the relational musculo-skeleton database, only a small subset of all the data required to reconstruct the hairstyle is required in each symbol

Hair attributes such as color, shininess, and curliness can be controlled through their respective attribute symbol boxes. The parameters described in these boxes are modified using simple common controls such as scroll bars and standard color selection utilities common to computer operating systems.

Hair modification symbol boxes are used to represent complex operations on the hair line and hairstyle geometry. A single modification symbol box may represent hundreds of individual geometric manipulations. For example, individual hair bundles may be scaled, repositioned, cut, twisted, braided, or curled using 3D modeling tools specific for each type of modification. The results of these modifications are stored as a chain of geometric commands as the user works with the tools. The commands are stored in a form that can be applied to a given hair building block to achieve identical results for future evaluations.

Hair may not be fully represented during Symbol Sequence editing. This is because-the complete rendering of a hairstyle takes considerable computing resources, which may preclude the option of displaying the results interactively. Instead, a simple facsimile of the hairstyle is presented to the user for direct editing. The final results of any hair styling work can only be viewed after a complete render is performed by the computer system.

Hair rendering is handled by a complex algorithm that treats each hair strand as a physical entity with its own geometry and attributes. Both ray-tracing and line-scan rendering techniques are employed in a hybrid approach that produces a highly realistic result.

In the preferred implementation, clothing is modeled in much the same way as the skin models described above. Individual clothing articles are compiled into building blocks which can added to a Symbol Sequence. Each building block contains the information necessary to place the clothing article in the correct location on the human form, and is scaled to fit the human's current size and shape.

Once in place, each clothing article's attributes can be controlled by adding clothing attribute symbol boxes. For example, fabric types, colors, and light absorption properties can be set using the simple control utilities within individual attribute symbol boxes. Many of these attributes will only become apparent when the clothing is fully rendered.

Clothing can be further modified by adding clothing modifier symbol boxes. The symbol boxes contain all of the 3D modeling tools required to edit seams, buttons, hem lines, and an assortment of other tailoring options. The results of these modifications are stored in a chain of geometric commands as the user works with the tools. The commands are stored in a form that can be applied to a given clothing building block to achieve identical results for future evaluations.

Clothing rendering is done using common computer graphic techniques. For example, facsimiles of clothing textures are imported into the computer systems from other sources. During rendering, these “texture maps” are applied to the clothing so that it can take on the appearance of the original article used to create the texture maps.

In the preferred implementation, each human entity contains all of the data required to reproduce its internal and external features. FIG. 11 illustrates that whenever a new human 65 is created in the system, it contains the following elements (see Table 4):

TABLE 4
Elements that are contained in a new human

Musculo-Skeleton 66
The relational database that provides all of the data necessary to construct
geometric models of the human
Symbol Sequence 67
Body: a specific group of symbol boxes describing body traits
Hair: symbols describing a base hairstyle and all of its custom styling
operations.
Clothing: symbols describing a basic wardrobe together with
custom tailoring.
Geometric NURBS Models 68, 69, 70
The “real thing”, generated in custom fashion from the musculo-skeleton
and symbol sequence description. These models are maintained as long as
the human exists, and are destroyed when no longer needed.

Surprising and unpredictable results may come from the evaluation of symbol sequences. For example, changing the ordering of shape modifier symbols in a sequence may result in striking differences in the human model. Accomplished users will learn to associate certain combinations of symbols with certain visual results through experimentation. Short subsequences of symbols saved in libraries will become useful in constructing sophisticated models with interchangeable traits.

When a human character is animated, the relational musculo-skeleton database is preferably re-evaluated to render each frame of the output animation. Only when the results of these computations are viewed as a sequence of images, do details of the deformation of the musculature and skin become apparent. These results will provide clues on how to improve the human model through further Symbol Sequence modifications. The most valuable benefit offered by the computer system is the ability to quickly refine sophisticated human models by repeating this two-step process: modify sequence, and render the test animation.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures form the present disclosure as come within known or customary practice within the art to -which the invention pertains.

1. A method for generating a data set for a virtual 3D character model comprising:
providing a generic musculo-skeleton model containing skeleton, musculature, cartilage, fat and skin components, including relative geometry model data defining a spatial relationship between control points of said components;
providing specification data for a plurality of trait parameters each of said trait parameters modifying at least one of said components of said generic musculo-skeleton model;
generating an Instance of said generic musculo-skeleton model using said specification data and said relative geometry model data to obtain said virtual 3D character model data set;
whereby said virtual character model data set can be used to model an outer surface of a more realistic virtual 3D character.

2. A method as claimed in claim 1, further comprising a user specifying said specification data.

3. A method as claimed in claim 2, wherein said specifying said specification data comprises ordering said plurality of trait parameters in a specific order and wherein said generating an Instance comprises applying said trait parameters to said musculo-skeleton model in said specific order.

4. A method as claimed in claim 1, further comprising displaying said generic musculo-skeleton model.

5. A method as claimed in claim 1, further comprising displaying said instance of said generic musculo-skeleton model.

6. A method as claimed in claim 2, wherein said generating an instance is carried out after specifying each of said plurality of trait parameters.

7. A method as claimed in claim 6, wherein said instance Is displayed after specifying said specification data.

8. A method as claimed in claim 2, wherein said specifying said specification data Is done by selecting a group of trait parameters.

9. A method as claimed in claim 1, further comprising a step of specifying a new trait parameter by creating a set of relative geometry model data for said new trait parameter.

10. A method as claimed in claim 1, further comprising
specifying clothing parameters; and
generating an instance of said generic musculo-skeleton model using said clothing parameters and said relative geometry model data to obtain said virtual character model data set.

11. A method as claimed in claim 1, further comprising
specifying hair parameters; and
generating an instance of said generic musculo-skeleton model using said hair parameters and said relative geometry model data to obtain said virtual character model data set.

12. A method as claimed in claim 2, wherein said specifying comprises specifying a sequence of modifications to be applied to said generic musculo-skeleton in order to produce a desired human being, wherein the result is sequence dependent.

13. A method as claimed in claim 12, wherein said modifications are encapsulated Inside individual symbol box user interface entities, and wherein a collection of symbol boxes forms a symbol sequence which fully describes traits of said human being.

14. A method as claimed in claim 1, further comprising a step of storing said virtual character model data set by storing an offset of said instance of said generic musculo-skeleton model with respect to said generic musculo-skeleton model.

15. A method as claimed in claim 1, further comprising a step of sending an output signal, said output signal containing said virtual character model data set.

16. A method as claimed in claim 1, wherein said providing comprises receiving an input signal from a remote source.

17. A computer readable memory for storing programmable instructions for use in the execution In a computer of the method of any one of claims 1 to 16.

18. A computer data signal embodied in a carrier wave, in a system for generating a data set for a virtual 3D character model, comprising:
said virtual character model data set generated according to the method defined in any one of claims 1 to 16.

19. A computer data signal embodied in a carrier wave, and representing sequences of instructions which, when executed by a processor, cause the processor to generate a data set for a virtual 3D character model by:
providing a generic musculo-skeleton model containing skeleton, musculature, cartilage, fat and skin components, including relative geometry model data defining a spatial relationship between control points of said components;
providing data for a plurality of trait parameters each of said trait parameters modifying at least one of said components of said generic musculo-skeleton model; and
generating an instance of said generic musculo-skeleton model using said data and said relative geometry model data to obtain said virtual character model data set;
whereby said virtual character model data set can be used to model a more realistic virtual character.
